(19) United States
(12) Patent Application Publication
(10) Pub. No.: US 2024/0430615 A1
(43) Pub. Date: Dec. 26, 2024

(54) ELECTRONIC INSTRUMENT AND ELECTRONIC KEYBOARD INSTRUMENT

(71) Applicant: CASIO COMPUTER CO., LTD., Tokyo (JP)

(72) Inventors: Hiroki AKAI, Tokyo (JP); So SATO, Tokyo (JP)

(21) Appl. No.: 18/744,326

(22) Filed: Jun. 14, 2024

(30) Foreign Application Priority Data
Jun. 26, 2023 (JP) 2023-103890

(51) Int. Cl. H04R 1/34; G10H 1/34; H04R 1/26

(52) U.S. Cl. CPC H04R 1/345; G10H 1/344; H04R 1/26; G10H 2220/221

(57) ABSTRACT

An electronic instrument includes a casing, a controller having multiple operation elements provided in connection with the casing and aligned in a left-right direction of the casing, a sound emitting unit including a low-pitched sound emitting unit provided on a first side in the left-right direction in the casing and configured to emit a low-pitched sound and a high-pitched sound emitting unit provided on a second side in the left-right direction in the casing and configured to emit a high-pitched sound, and a reflection unit having a reflection surface configured to reflect a sound and provided between the low-pitched sound emitting unit and the high-pitched sound emitting unit in the casing, and the reflection unit is configured such that the reflection surface is inclined towards the high-pitched sound emitting unit with respect to the left-right direction.

### CROSS-REFERENCE TO RELATED APPLICATION

This application is based upon and claims the benefit of priority under 35 USC 119 of Japanese Patent Application No. 2023-103890 filed on Jun. 26, 2023, the entire disclosure of which, including the specification, claims, drawings and abstract, is incorporated herein by reference in its entirety.

### BACKGROUND

### Technical Field

The present disclosure relates to an electronic instrument and an electronic keyboard instrument.

### Description of the Related Art

There have conventionally been known electronic instruments which can obtain a key press feeling and tones which are closer to those provided by a real piano. For example, Japanese Unexamined Patent Application Publication No. 2003-302974 (JP-A-2003-30297) discloses an electronic organ (an electronic instrument) including an organ main body, a keyboard, and a loudspeaker accommodated in the organ main body and configured to produce electronic sounds as keys of the keyboard are pressed. In this electronic organ, a reflection plate is provided on a sound emitting side of the loudspeaker, so that the audience can listen to played sounds in a better condition which include sounds in a high-pitched sound range as a result of a sound emitted from a sound emitting surface of the loudspeaker being reflected by the reflection plate.

### SUMMARY

According to an aspect of the present disclosure, there is provided an electronic instrument including a casing, a controller having multiple operation elements provided in connection with the casing and aligned in a left-right direction of the casing, a sound emitting unit including a low-pitched sound emitting unit provided on a first side in the left-right direction in the casing and configured to emit a low-pitched sound and a high-pitched sound emitting unit provided on a second side in the left-right direction in the casing and configured to emit a high-pitched sound, and a reflection unit having a reflection surface configured to reflect a sound and provided between the low-pitched sound emitting unit and the high-pitched sound emitting unit in the casing, wherein the reflection unit is configured such that the reflection surface is inclined towards the high-pitched sound emitting unit with respect to the left-right direction.

According to another aspect of the present disclosure, there is provided an electronic keyboard instrument including the electronic instrument described above, wherein the controller includes a keyboard having multiple keys.

### BRIEF DESCRIPTION OF THE DRAWINGS

FIG. 1 is an overall perspective view of an electronic keyboard instrument according to an embodiment of the present disclosure as viewed from a front side;

FIG. 2 is a perspective view of a main body part of the electronic keyboard instrument according to the embodiment as viewed from a back side;

FIG. 3 is a perspective view of the main body part of the electronic keyboard instrument according to the embodiment as viewed from the front side with a front top plate and a back top plate removed;

FIG. 4 is a sectional view of the main body part of the electronic keyboard instrument according to the embodiment, which is a sectional view taken along a line IV-IV in FIG. 2; and

FIG. 5 is a perspective sectional view of the main body part of the electronic keyboard instrument according to the embodiment, which is a perspective sectional view of a section corresponding to the sectional view in FIG. 4.

### DESCRIPTION OF THE EMBODIMENT

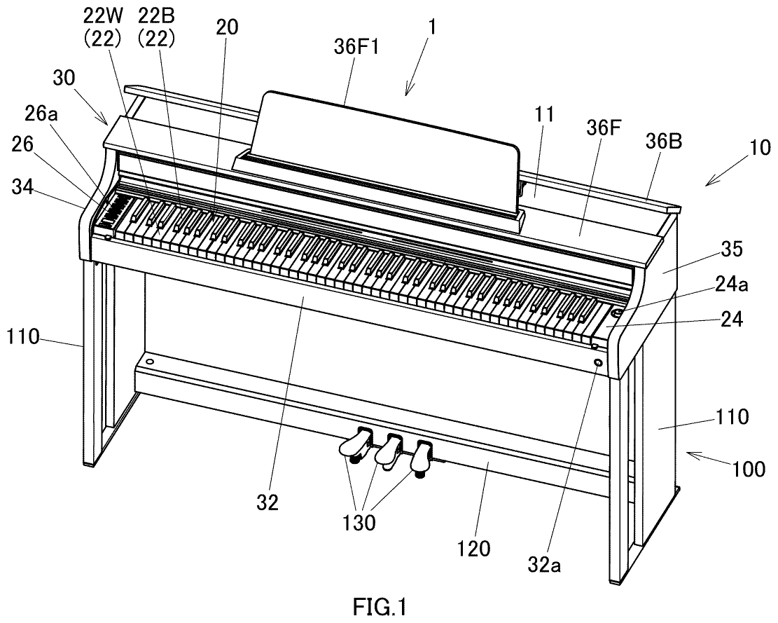

Referring to drawings, an embodiment of the present disclosure will be described. An electronic keyboard instrument (an electronic instrument) 1 shown in FIG. 1 includes a main body part 10 and a leg part 100. As shown in FIG. 1, the main body part 10 includes a keyboard (a controller) 20 and a main body case (a casing) 30 which surrounds the keyboard 20 to hold it. The keyboard 20 has multiple keys 22 made up of white keys 22W and black keys 22B, and in the keyboard 20, a key press section is provided in such a manner as to be exposed to an exterior of the keyboard 20. The leg part 100 includes a pair of side plates 110, a pedal frame 120, and a pedal device 130. In the following description, an alignment direction of the multiple keys 22 of the keyboard 20 is referred to as a left-right direction (in FIG. 1, a direction towards a left side is referred to as a leftward direction), an extending direction of each key 22 is referred to as a front-back direction (in FIG. 1, a direction towards a nearer side is referred to as a frontal direction), and an upper-lower direction of the electronic keyboard instrument 1 is referred to as an upper-lower direction (in FIG. 1, a direction towards an upper side is referred to as an upper direction).

As shown in FIG. 1, the pair of side plates 110 are plates which are erected on a setting surface on both left and right sides of the electronic keyboard instrument 1 in such a posture that both plate surfaces of each plate are oriented in the left-right direction so as to support the main body case 30. The pedal frame 120 extends between the side plates 110 to connect them together at lower sides of the side plates 110. The pedal device 130 is provided substantially at a central portion of the pedal frame 120 in the left-right direction. In the electronic keyboard instrument 1, the main body case 30 of the main body part 10, which is exposed to an exterior of the electronic keyboard instrument 1, and both the side plates 110 of the leg part 100 are made of wood, whereby the quality of the electronic keyboard instrument 1 is characterized by these wood constituent components. Hereinafter, a configuration of the main body port 10 will be described in detail.

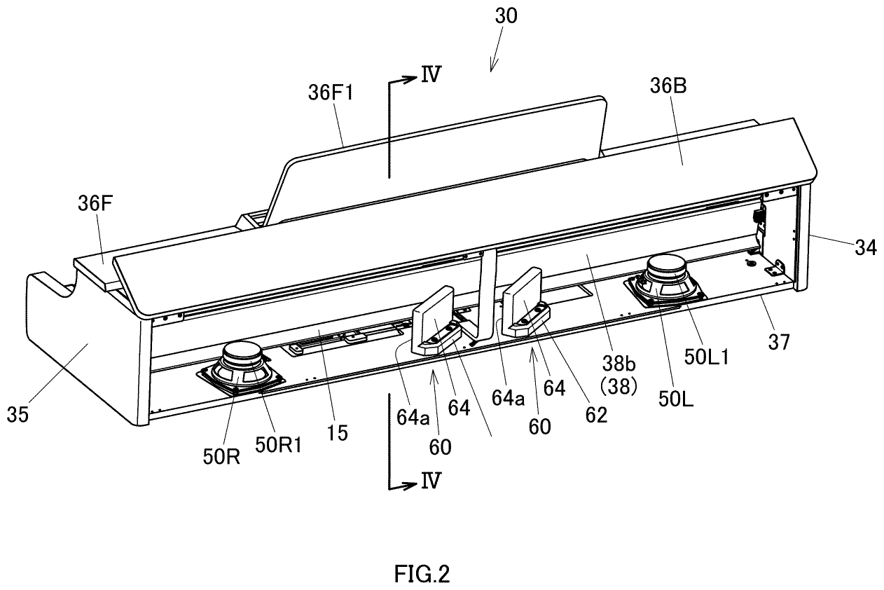

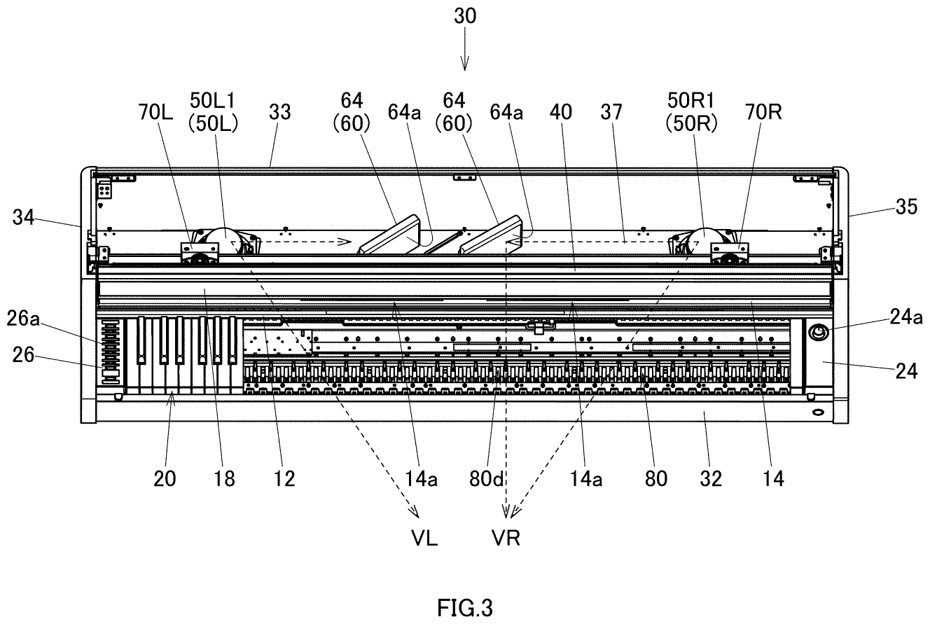

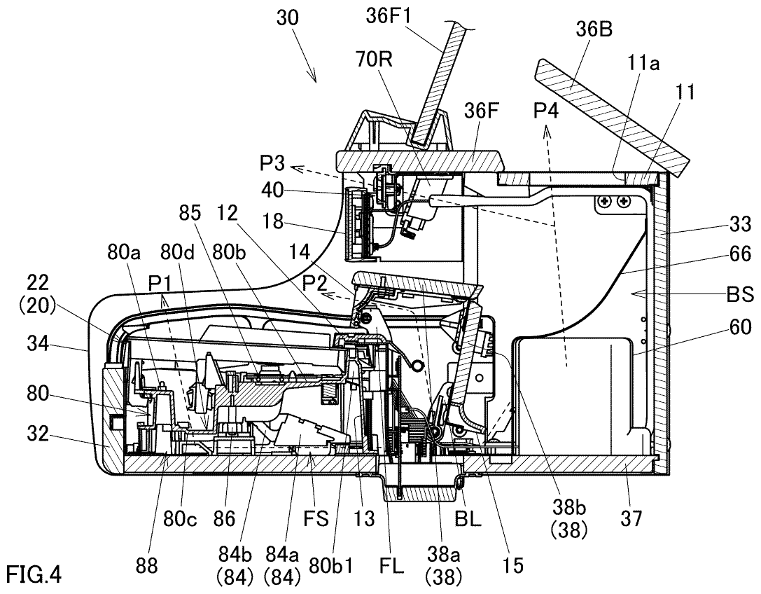

As shown in FIGS. 1 to 4, when viewed from an upper side and a lower side thereof, the main body case 30 has a substantially rectangular shape which is elongated laterally in such a manner that a longitudinal direction thereof follows the left-right direction and has thick plates such as a front plate 32, a back plate 33, a left side plate 34, a right side plate 35, a front top plate 36F, a back top plate 36B, and a lower plate (bottom plate) 37. In addition, the main case body 30 has a vertical section of substantially an L-shape (refer to FIG. 4). Here, in FIG. 2, the main body case 30 is shown being in a state in which the back plate 33 is removed, and in FIG. 3, the main body case 30 is shown being in a state in which the front top plate 36F and the back top plate 36B are removed. The front plate 32 has a substantially rectangular shape which is elongated in the left-right direction and is provided at a lower portion of a front end portion of the main body part 10 and on a lower side of the keyboard 20, constituting a front surface of the main body case 30. A power supply button 32a is provided at a right end portion of the front plate 32 (refer to FIG. 1). The back plate 33 has a substantially rectangular shape which is elongated in the left-right direction and is provided on a back side of the main body part 10, constituting a back surface of the main body case 30.

The left side plate 34 and the right side plate 35 each have a substantially rectangular shape which is elongated in the front-back direction. In each of the left side plate 34 and the right side plate 35, a step is provided at a substantially central portion in the front-back direction so that a height of a front half portion becomes substantially equal to the height of the keyboard 20. The left side plate 34 and the right side plate 35 are provided individually on a left side and a right side of the main body part 10, constituting a left side surface and a right side surface of the main body case 30, respectively. The front top plate 36F has a substantially rectangular shape which is elongated in the left-right direction and is provided on a front side of an upper backward portion of the main body part 10, constituting a part of an upper surface of the main body case 30. The back top plate 36B has a substantially rectangular shape which is elongated in the left-right direction and is provided on a back side of the upper backward portion of the main body part 10, constituting a part of the upper surface of the main body case 30. Here, as shown in FIGS. 1 and 3, a volume panel 24 on which a volume knob 24a and the like are disposed is provided between the keyboard 20 and the right side plate 35. In addition, a setting panel 26 on which various types of setting buttons 26a are disposed is provided between the keyboard 20 and the left side plate 34.

As shown in FIGS. 1 and 4, the back top plate 36B is attached rotatably to the back plate 33 in such a manner that the back plate 33 is opened from a front side thereof. A cover plate 11, having a substantially rectangular plate-like shape which is elongated in the left-right direction, is provided on a lower side of the back top plate 36B in such a posture that both plate surfaces thereof are oriented in the upper-lower direction. Multiple upper openings 11a, each having a substantially rectangular shape and opened upwards, are provided in the cover plate 11 in such a manner as to be disposed at predetermined intervals in the left-right direction (refer to FIG. 4). An upper surface and side surfaces of the cover plate 11 are covered with a saran net. With the back top plate 36B left open, an opening on a lower side of the back top plate 36B is covered by the cover plate 11, so that an interior of the main body case 30 is made invisible. In addition, a music stand 36F1 is attached to a substantially central portion of the front top plate 36F in the left-right direction thereof. The lower plate 37 has a substantially rectangular shape which is elongated in the left-right direction and is provided on a lower side of the main body part 10, constituting a lower surface of the main body case 30.

As shown in FIGS. 3 and 4, a console unit 12, having a substantially rectangular plate-like shape which is elongated in the left-right direction, is provided on back sides of the keys 22 of the keyboard 20 in such a posture that both plate surfaces thereof are oriented in the upper-lower direction. The console unit 12 is provided in a position where the console unit 12 is superposed on a front end portion of the front top plate 36F in the upper-lower direction in such a manner as to cover back end portions of the keys 22 of the keyboard 20. The console unit 12 prevents the interior of the main body case 30 from becoming visible via a gap at a back end portion of the keyboard 20 from an exterior of the electronic keyboard instrument 1. In addition, the keys 22 are restricted from moving in the front-back direction by providing the console unit 12 on the back sides of the keys 22.

As shown in FIG. 4, multiple first metallic sheets 13, each having a substantially plate-like shape and extending downwards in such a posture that both sheet surfaces thereof are oriented in the front-back direction, are provided at a back end portion of a lower surface of the console unit 12 in such a manner as to be disposed at predetermined intervals along the left-right direction. The lower end portions of the first metallic sheets 13 are attached to the lower plate 37. A back side of the keyboard 20 is fixed to the main body case 30 by the first metallic sheets 13. A space defined on front sides of the first metallic sheets 13 constitutes a space provided below the keyboard 20. Multiple notches, not shown, are provided individually in lower end portions of the first metallic sheets 13. In the interior of the main body case 30, the space defined on the front sides of the first metallic sheets 13 and a space defined on back sides of the first metallic sheets 13 are made to communicate with each other interspaces between the multiple first metallic sheets 13 and the notches provided in the first metallic sheets 13.

As shown in FIG. 3, in the main body case 30, a section defined between the front plate 32 and the console unit 12 is opened forwards and upwards, so that upper surfaces, constituting key press portions, and portions of front surfaces of the keys 22 of the keyboard 20 are exposed to the outside from this open section. As shown in FIGS. 3 and 4, the main body part 10 includes a key cover 38 for covering the section of the keyboard 20 which is exposed to the outside. The key cover 38 is made up of a thick plate and includes a front cover section 38a and a back cover section 38b, which are each made up of a plate having a substantially rectangular shape which is elongated in the left-right direction. Then, the front cover section 38a and the back cover section 38b are aligned parallel in the front-back direction. The front cover section 38a is rotatably connected with a front link FL fixed to the main body case 30 via a front attachment 14, which is laterally elongated. Two attachment openings 14a, each having a substantially rectangular shape which is laterally elongated, are provided individually on a left side and a right side of a central portion (a handle section) of the front attachment 14 in the left-right direction in such a manner as to be opened to penetrate the front attachment 14 (refer to FIG. 3).

The back cover section 38b is rotatably connected with a back link BL fixed to the main body case 30 via a back attachment 15, which is laterally elongated. The front cover section 38a and the back cover section 38b are coupled together via a hinge in such a manner as to be folded into two sections and are accommodated in the space defined on the back sides of the first metallic sheets 13 in the interior of the main body case 30 in such a manner that the key cover 38 can freely be pulled into and out of the relevant space through a gap defined between the console unit 12 and an operation plate 18, which will be described later. In the electronic keyboard instrument 1, when the power supply is switched off, the key cover 38 is pulled out of the interior of the main body part 10 to cover the open section of the main body case 30 where the keyboard 20 is exposed, whereby the exposed section of the keyboard 20 is designed to be covered.

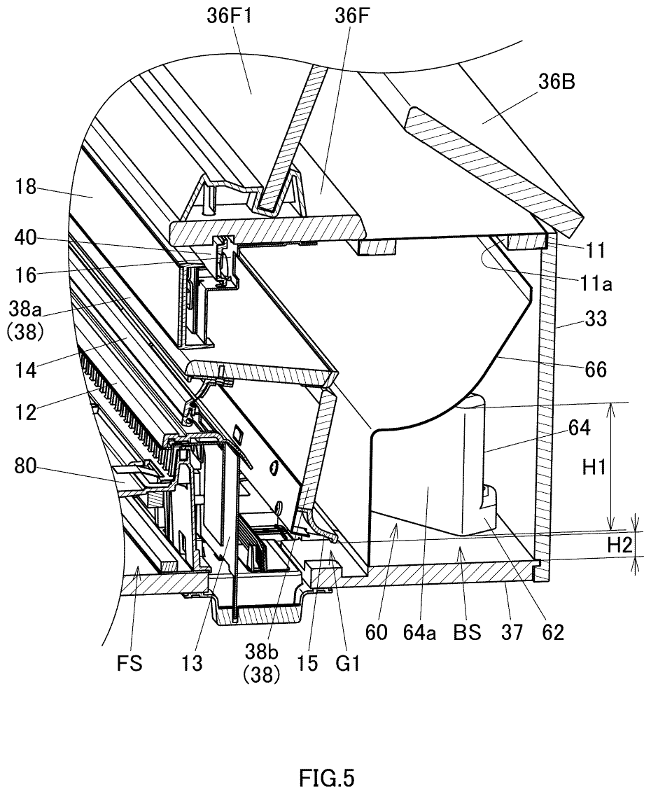

In the electronic keyboard instrument 1, when the keyboard 20 is covered by the key cover 38, the gap defined between the console unit 12 and the operation plate 18 is covered by the back attachment 15. Additionally, in such a state that the key cover 38 is accommodated in the space defined on the back sides of the first metallic sheets 13 when the power supply is switched on, a slight gap (hereinafter, referred to as a “communication gap G1” (refer to FIG. 5)) is defined between the lower plate 37 and the back attachment 15. As a result of this, with the key cover 38 accommodated accordingly, the interior of the main body case 30 is defined into a front space FS defined on a front side of the key cover 38 and a back space BS defined on a back side of the key cover 38.

As shown in FIGS. 3 and 5, a second metallic sheet 16 is attached to a lower surface of the front top plate 36F (not shown in FIG. 3) in such a manner as to extend in the left-right direction. The operation plate 18, having a substantially thick rectangular plate-like shape which is elongated in the left-right direction, is provided at a front end portion of the second metallic sheet 16 in such a posture that both sheet surfaces thereof are oriented in the front-back direction. The operation plate 18 is provided between the key cover 38 and the front top plate 36F in such a state that the operation plate 18 is disposed in a position where gaps are defined on both upper and lower sides thereof in such a manner as to be opened towards the front side. Most of a gap defined between the key cover 38 and the front top plate 36F is covered by the operation plate 18, whereby the back space BS is made invisible. A part of a front surface of the operation plate 18 is made into a touch panel, where multiple switches, not shown, are provided to receive touch operations. As a result, the operation plate 18 has a touch operation detection mechanism for enabling a touch operation and an LED light emitting mechanism for illuminating the switches in an interior thereof.

A perforated unit 40, having a substantially rectangular plate-like shape which is elongated in the left-right direction, is attached with screws to a front side of the second metallic sheet 16 in such a posture that both unit surfaces thereof are oriented in the front-back direction. The perforated unit 40 is formed from a resin through injection molding, and multiple holes are provided in such a manner as to penetrate the perforated unit 40 in a thickness direction thereof. Then, the perforated unit 40 is provided on the second metallic sheet 16 on a back side of the operation plate 18 in such a manner as to define a slight gap between the operation plate 18 and itself in the front-back direction. As shown in FIG. 4, a lower portion of the perforated unit 40 overlaps the operation plate 18 in the front-back direction.

As shown in FIGS. 2 and 3, the electronic keyboard instrument 1 includes two loudspeakers 50R, 50L on a back side of an upper surface of the lower plate 37 in the back space BS. Both the loudspeakers 50R, 50L are provided downwards and backwards of the keyboard 20 in such a manner that sound emitting sections 50R1, 50L1, each having a shape of frustum of circular cone, are disposed above the lower plate 37. Sounds emitted from the sound emitting sections 50R1, 50L1 are emitted into the back space BS. Of the two loudspeakers 50R, 50L, the loudspeaker 50R (hereinafter, also referred to as a “right loudspeaker (a high-pitched sound emitting unit) 50R”)) is provided on an upper surface of the lower plate 37 in a position lying closer to the right side and functions to emit sounds in a high-pitched sound range. The loudspeaker 50L (hereinafter, also referred to as a “left loudspeaker (a low-pitched sound emitting unit) 50L”)) is provided on the upper surface of the lower plate 37 in a position lying closer to the left side in such a manner as to be aligned parallel to the right loudspeaker 50R in the left-right direction and functions to emit sounds in a low-pitched sound range.

Two reflection units 60, configured to reflect mainly a sound emitted from the right loudspeaker 50R, are provided parallel to each other in the left-right direction on a back side of the upper surface of the lower plate 37 while being disposed between the two loudspeakers 50R, 50L, specifically, in a position lying closer to a central portion in the left-right direction. In other words, the loudspeakers 50R, 50L are provided individually on the left and right end sides in the left-right direction in the main body case 30, and the reflection units 60 are provided at the central portion in the left-right direction in the main body case 30. The reflection units 60 each have a thick plate-shaped screwed section 62 which is attached with screws to the upper surface of the lower plate 37 and a thick plate-shaped raised section 64 which is raised substantially perpendicular to the lower plate 37 from one end portion of the screwed section 62, and are each formed from foamed styrene, foamed polypropylene, or the like.

The reflection units 60 are each disposed in such a posture that both plate surfaces of the raised section 64 are slightly inclined towards the right loudspeaker 50R with respect to the left-right direction. The plate surface of the raised section 64 of each reflection unit 60 which is oriented to the front side is made into a reflection surface 64a for reflecting a sound. That is, the reflection units 60 are each provided in such a manner that the normal direction of the reflection surface 64a is oriented more towards the right loudspeaker 50R. Specifically speaking, the reflection units 60 are each put in such a posture that the normal direction of the reflection plate 64a is inclined at about 35 degrees towards the right loudspeaker 50R with respect to the left-right direction.

In the present embodiment, the reflection surface 64a is inclined towards the right loudspeaker 50R, and hence, at least a part of a sound emitted from the right loudspeaker 50R is reflected towards the front side and a substantially central portion in the left-right direction by the reflection surface 64a. As shown in FIG. 5, a space defined on a front side of the reflection surface 64a and a space defined on a lower side of the keyboard 20 (the front space FS) communicate with each other by way of the communication gap G1. A height dimension H1 of each reflection surface 64a is made substantially equal to height dimensions of the right and left loudspeakers 50R, 50L and is made larger than a height dimension H2 of the communication gap G1. As a result, a sound in the high-pitched sound range emitted from the right loudspeaker 50R and reflected by the reflection surfaces 64a passes through the communication gap G1 to easily reach the space defined on the lower side of the keyboard 20.

As shown in FIG. 5, a single saran net 66 of a substantially rectangular shape is provided above the two reflection units 60 in the back space BS. A left-right dimension of the saran net 66 is made substantially equal to a left-right dimension of the back space BS, and a front-back dimension of the saran net 66 is made longer than a space defined between the key cover 38 and the back plate 33. The saran net 66 is disposed to be curved obliquely downwards at the back into the shape of a convex arc. Then, a back end portion of the saran net 66 is fixed to the back plate 33, while a front part of the saran net 66 is bent substantially perpendicularly downwards, so that a front end portion of the saran net 66 is fixed to the lower plate 37. The saran net 66 extends over the two loudspeakers 50R, 50L and the two reflection units 60 in such a manner as to cover them from above, whereby the two loudspeakers 50R, 50L and the two reflection units 60 are prevented from becoming visible through the gap defined between the operation plate 18 and the front top plate 36F, or the like.

In addition, as shown in FIG. 3, tweeters 70R, 70L are provided individually in positions lying obliquely upwards to the front side from the corresponding loudspeakers 50R, 50L in the back space BS. The tweeters 70R, 70L each have a substantially circular cylindrical shape and are attached to an internal surface side of the second metallic sheet 16 in such a manner that a direction of a cylindrical axis and an emitting direction of a sound are oriented obliquely upwards to the front side. Hereinafter, the tweeter 70R provided at a right end side of the back space BS is also referred to as “a right tweeter 70R”, and the tweeter 70L provided at a left end side of the back space BS is also referred to as “a left tweeter 70L”. The right tweeter 70R and the left tweeter 70L are provided so as to face a right end side and a left end side of the perforated unit 40, respectively, above the keyboard 20 in such a manner as to define a space between the perforated unit 40 and themselves. Then, sounds emitted from the right and left tweeters 70R, 70L are designed to reach the perforated unit 40.

Subsequently, configurations of constituent components provided in the front space FS will be described. As shown in FIG. 4, a first support 80 is provided on the front sides of the first metallic sheets 13 in the front space FS. The first support 80 is provided over substantially a whole area of the lower side of the keyboard 20 and is laterally elongated as with the keyboard 20. The first support 80 is a hollow component which is opened downwards. The keyboard 20 is supported on the main body case 30 by the first support 80 and a second support 88, which will be described later. The second metallic sheet 16 described above is provided on a back side of the first support 80.

A front end portion of the first support 80 is made into a convex section 80a which protrudes upwards into a convex shape. A portion of the first support 80 which is positioned on lower sides of the black keys 22B of the keys 22 is made into a platform section 80b which protrudes upwards into a platform-like shape. A portion of the first support 80 lying between the convex section 80a and the platform section 80b is made into a concave section 80c which is recessed downwards into a concave shape. A rotatable fulcrum portion 80b1 is provided at a back portion of an upper surface of the platform section 80b so as to support rotatably back end portions of the keys 22 of the keyboard 20. Additionally, a control substrate 85 is provided on the upper surface of the platform section 80b. Switches are provided on the control substrate 85 so as to produce sounds corresponding to the keys 22 which are pressed. Multiple concave section openings 80d, which are opened in the front-back direction and the left-right direction, are provided in the concave section 80c in such a manner as to be aligned side by side in the left-right direction (refer to FIG. 3).

Multiple hammers 84, which are connected with the corresponding keys 22, are provided in a part of a space defined inside the first support 80 which lies below the platform section 80b. The hammer 84 includes a substantially triangular weight section 84a and an arm section 84b, which extends in a straight line to the front side from the weight section 84a. The arm section 84b is rotatably supported on a pivot 86 provided in a front portion of the space defined inside the first support 80. When the key 22 is pressed, the weight section 84a of the corresponding hammer 84 is raised, whereby a feeling of heaviness can be felt by the player when he or she presses the key 22. This makes it possible to obtain a key press feeling close to that provided by a real piano.

The second support 88 is disposed on the lower plate 37 and is provided in a portion of the space defined inside the first support 80 which lies further forwards than a portion where the hammer 84 is disposed. The second support 88 is a hollow component which is opened downwards and is attached to the main body case 30 by being screwed down on the lower plate 37. The keyboard 20 is indirectly supported on the main body case 30 made of wood via the first support 80 by the second support 88. The pivot 86 which supports the arm section 84b of the hammer 84 is provided on the second support 88.

Subsequently, communication paths P1 to P4 will be described. The communication paths P1 to P4 are provided in the interior of the main body case 30 and constitute sound emitting paths for sounds emitted from the loudspeakers 50R, 50L. As shown in FIG. 4, in the electronic keyboard instrument 1 according to the present embodiment, four communication paths P1 to P4 are provided in the main body case 30 as sound emitting paths along which sounds emitted from the two loudspeakers 50R, 50L are emitted to reach the outside of the main body case 30. A first communication path P1, which is a first communication path, constitutes a communication path which extends from the two loudspeakers 50R, 50L to reach the front space FS by way of the communication gap G1, passes underneath the hammers 84 to extend further from the concave section openings 80d to above the first support 80, and passes interspaces defined between the keys 22 to reach the outside of the main body case 30.

A second communication path P1, which is a second communication path, constitutes a communication path which extends from the two loudspeakers 50R, 50L to reach the back sides of the first metallic sheets 13 by way of the communication gap G1, passes the back sides of the first metallic sheets 13 to extend upwards, and extends further from the attachment openings 14a to reach the outside of the main body case 30. Here, a sound in the high-pitched sound range is characterized by vibrating more in the air than a sound in the low-pitched sound range and being easily attenuated, and hence, a sound in the high-pitched sound range emitted from the right loudspeaker 50R is hard to reach a nearer side of the main body case 30 when compared with a sound in the low-pitched sound range emitted from the left loudspeaker 50L. In the present embodiment, at least a part of a sound in the high-pitched sound range emitted from the right loudspeaker 50R to travel by way of the first communication path P1 and the second communication path P2 is reflected towards the communication gap G1 by the reflection surfaces 64a of the two reflection units 60 which are disposed inclined towards the right loudspeaker 50R to reach the back sides of the first metallic sheets 13.

On the other hand, a sound in the low-pitched sound range emitted from the left loudspeaker 50L to travel by way of the first communication path P1 and the second communication path P2 is hard to reach directly the reflection surfaces 64a of the two reflection units 60 which are disposed inclined towards the right loudspeaker 50R, and hence, there is no such situation that the sound in the low-pitched sound range emitted from the left loudspeaker 50L reaches the communication gap G1 excessively. That is, as shown in FIG. 3, the sound in the low-pitched sound range emitted from the left loudspeaker 50L travels by way of a sound emitting path which reaches the player sitting in a central position in the left-right direction on a nearer side of the electronic keyboard instrument 1 without striking the reflection surfaces 64a of the two reflection units 60 (refer to a dashed line arrow VL). On the other hand, the sound in the high-pitched sound range emitted from the right loudspeaker 50R travels by way of two sound emitting paths, that is, a sound emitting path along which the sound reaches the player without striking the reflection surfaces 64a and a sound emitting path along which the sound reaches the player after being reflected by the reflection surfaces 64a of the two reflection units 60 (refer to a dashed line arrow VR).

In this way, the sound in the high-pitched sound range emitted from the right loudspeaker 50R is made to reach the player via the combination of the sound emitting path along which the sound travels by way of the reflection units 64 and the sound emitting path along which the sound travels direct without involvement of the reflection units 64, whereby the attenuation is compensated for. This enables the sound in the high-pitched sound range and the sound in the low-pitched sound range which are emitted from the two speakers 50R, 50L, respectively, to reach the player in a well-balanced fashion. Here, as a modified example, a configuration may be adopted in which the reflection surface 64a of each reflection unit 64 is covered with a rubber material, whereby at least a part of the sound in the low-pitched sound range emitted from the left loudspeaker 50L is absorbed by the rubber material. As the result of adopting this configuration, sounds emitted from the two loudspeakers 50R, 50L can be emitted in a better-balanced fashion.

A third communication path P3, which is a third communication path, constitutes a communication path which extends from the two loudspeakers 50R, 50L upwards through the back space BS to pass through the holes provided in the perforated unit 40, and extends further from the gap defined between the operation plate 18 and the front top plate 36F to reach the outside of the main body case 30. Here, sounds emitted from the two tweeters 70R, 70L pass through the holes provided in the perforated unit 40 to reach the outside of the main body case 30, and hence, the sounds travel by way of at least a part of the third communication path P3. A fourth communication path P4, which is a fourth communication path, constitutes a communication path which extends from the two loudspeakers 50R, 50L upwards through the back space BS to reach the outside of the main body case 30 by way of the upper openings 11a in the cover plate 11.

In the present embodiment, at least a part of the sound in the high-pitched sound range which is emitted from the right loudspeaker 50R and travels by way of the third communication path 3P and the fourth communication path P4 is reflected towards the upper side of the back space BS by the reflection surfaces 64a of the two reflection units 60. As a result, the part of the sound in the high-pitched sound range which is emitted from the right loudspeaker 50R is made to reach the upper side of the back space BS efficiently. On the other hand, the sound in the low-pitched sound range which is emitted from the left loudspeaker 50L and travels by way of the third communication path P3 and the fourth communication path P4 does not reach the upper side of the back space BS excessively. This enables the sound in the high-pitched sound range and the sound in the low-pitched sound range which are emitted from the two speakers 50R, 50L, respectively, to reach the upper side of the back space BS in a well-balanced fashion.

In addition, the saran net 66 is characterized by absorbing a sound in the high-pitched sound range, and hence, a part of a sound in the high-pitched sound range which is emitted mainly from the right loudspeaker 50R and reaches the upper side of the back space BS by passing through the saran net 66 is so absorbed as a result of passing through the saran net 66. This restrains the sound in the high-pitched sound range which is reflected excessively by the reflection surfaces 64a of the two reflection units 60 from reaching the upper side of the back space BS excessively, thereby making it possible to transmit a well-balanced sound image to the player. With the electronic keyboard instrument 1 including the four communication paths P1 to P4 for emitting sounds as has been described heretofore, sounds can be emitted effectively from the interior of the main body case 30 towards the player (towards the front and the substantially central portion in the left-right direction of the main body case 30), thereby making it possible to obtain a good sound image.

Additionally, the two sound reflection units 60 are provided in such a manner as to be spaced apart from each other in the left-right direction, and this configuration enhances the reflection efficiency of the sound which is emitted from the right loudspeaker 50R to be reflected to the front side by the reflection surfaces 64a. Specifically speaking, for example, among a sound which is emitted from the right loudspeaker 50R to travel towards the reflection units 60, a sound component which is not reflected by the right reflection unit 64 (for example, a sound component which travels around the right reflection unit 64 to a back side of the right reflection unit 64) is reflected by the back plate 33 to reach the left reflection unit 64 and is then reflected by the left reflection unit 64 to thereby reach the player, thereby making it possible to enhance the reflection efficiency of a sound emitted from the right loudspeaker 50R.

As modified examples to the configuration in which the two reflection units 60 are provided individually leftwards and rightwards as described above, for example, there can be raised four modified examples as below. A first modified example provides a configuration in which the left reflection unit 64 is disposed in such a manner as to be brought into contact with an internal surface of the back plate 33. By adopting this configuration, the sound which is not reflected by the right reflection unit 64 can be reflected to the front side in a more ensured fashion by the left reflection unit 64. A second modified example provides a configuration in which the reflection surfaces 64a of the two reflection units 64 are inclined at different inclination angles from each other. In the case that the back space BS expands more in the front-back direction, the inclination angle of the reflection surface 64a of the left reflection unit 64 is set larger (for example, at 45 degrees), thereby making it possible to enhance the reflection efficiency of a sound towards the player.

A third modified example provides a configuration in which at least one of the two reflection units 60 is provided in such a posture that the reflection surface 64a is not substantially perpendicular to the lower plate 37. In the case that a sound emitted from the right loudspeaker 50R reaches the player by way of at least the four communication paths P1 to P4, the reflection unit 60 may be provided in such a posture that the reflection surface 64a is slightly inclined with respect to the lower plate 37. A fourth modified example provides a configuration in which a height dimension of the reflection surface 64a of the right reflection unit 60 is smaller than a height dimension of the reflection surface 64a of the left reflection unit 60 (however, larger than a height dimension of the communication gap G1), and the left reflection unit 60 is provided in such a posture that the reflection surface 64a of the left reflection unit 60 is inclined upwards. According to this configuration, a sound can be transmitted to the first communication path P1 and the second communication path P2 in a further ensured fashion by the right reflection unit 60, while a sound can be made to reach the third communication path P3 and the fourth communication path P4 easily by the left reflection unit 60.

Below, the electronic keyboard instrument 1 according to the present embodiment is described in comparison with the related technology. There may be a case in which a sound emitted from a loudspeaker is made to be emitted from an interior of a casing towards the head of a player so that the player can obtain a good sound image. With the electronic organ disclosed in JP-A-2003-302974, however, the loudspeaker is attached in such a state that the sound emitting surface is directed downwards, and a sound emitted from the loudspeaker is designed to be emitted from a lower side to an exterior of the organ main body to travel towards the reflection plate. With this configuration, a sound emitted from the loudspeaker and reflected by the reflection plate cannot be made to reach the player effectively, resulting in a risk that the sensation of uniformity of a sound reaching the player is reduced.

To solve the problems of the related technology mentioned above, the electronic keyboard instrument 1 according to the present embodiment includes the main body case 30, the keyboard 20 having the multiple keys 22 which are aligned in the left-right direction of the main body case 30, the loudspeakers 50R, 50L including the left loudspeaker 50L provided on the one side or the first side in the left-right direction in the main body case 30 and configured to emit a sound in the low-pitched sound range and the right loudspeaker 50R provided on the other side or the second side in the left-right direction in the main body case 30 and configured to emit a sound in the high-pitched sound range, and the reflection units 60 each having the reflection surface 64a configured to reflect a sound and provided between the left loudspeaker 50L and the right loudspeaker 50R in the main body case 30. Then, the reflection units 60 are provided in such a manner that the reflection surfaces 64a are inclined towards the right loudspeaker 50R with respect to the left-right direction.

With the electronic keyboard instrument 1 of the present embodiment, which is configured as described above, the sound in the high-pitched sound range emitted from the right loudspeaker 50R is reflected towards the player (the substantially central portion in the left-right direction on the nearer side of the main body case 30) by the reflection surfaces 64a of the two reflection units 60 which are disposed inclined towards the right loudspeaker 50R so as to reach the player efficiently. On the other hand, the sound in the low-pitched sound range e emitted from the left loudspeaker 50L is made hard to reach the reflection surfaces 64a of the two reflection units 60. This configuration functions to restrain large and small degrees of volumes of sounds reaching the player (variations in the sound in the high-pitched sound range and the sound in the low-pitched sound range) from locally scattering in the left-right direction, thereby making it possible to enhance the uniformity of the sounds reaching the player.

Additionally, with the electronic keyboard instrument 1 according to the present embodiment, the two loudspeakers 50R, 50L are provided downwards and backwards of the keyboard 20. With the electronic keyboard instrument 1, the player is positioned on the front side or the nearer side of the keyboard 20, and hence, the configuration described above can provide the specific positions where to provide the two loudspeakers 50R, 50L to make the sound in the high-pitched sound range reflected by the reflection surfaces 64a of the two reflection units 60 reach the player effectively.

The electronic keyboard instrument 1 according to the present embodiment has in the main body case 30 the first communication path P1 which extends from the two loudspeakers 50R, 50L to reach the key gaps defined between the multiple keys 22 by way of the front sides of the reflection surfaces 64a and the lower side of the keyboard 20. This can provide the specific configuration in which the sound in the high-pitched sound range emitted from the right loudspeaker 50R and reflected by the reflection surfaces 64a is emitted from the key gaps between the multiple keys 22 towards the player, thereby making it possible to further enhance the uniformity of the sound reaching the player.

In the electronic keyboard instrument 1 according to the present embodiment, the main body case 30 has the communication gap G1 configured to establish a communication between the front sides of the reflection units 60 and the lower side of the keyboard 20. Then, the first communication path P1 constitutes the communication path which extends by way of the communication gap G1. The height dimension H1 of the reflection surface 64a is made larger than the height dimension H2 of the communication gap G1. According to this configuration, the sound in the high-pitched sound range emitted from the right loudspeaker 50R and reflected by the two reflection surfaces 64a can be made to reach the communication gap G1 easily. This can realize the configuration in which the sound in the high-pitched sound range emitted from the right loudspeaker 50R can easily reach the player by way of the first communication path P1, thereby making it possible to further enhance the uniformity of the sound reaching the player.

Additionally, the electronic keyboard instrument 1 according to the present embodiment has in the main body case 30 the second communication path P2 which extends from the two loudspeakers 50R, 50L to reach above or the upper side of the keyboard 20 by way of the front sides of the two reflection surfaces 64a. This can provide the specific configuration in which the sound in the high-pitched sound range emitted from the right loudspeaker 50R and reflected by the two reflection surfaces 64a is emitted from the upper side of the keyboard 20 towards the player, thereby making it possible to enhance further the uniformity of the sound reaching the player.

In addition, the electronic keyboard instrument 1 according to the present embodiment has in the main body case 30 the third communication path P3 which extends from the two loudspeakers 50R, 50L to reach above or the upper side of the keyboard 20 by way of the upper sides of the two reflection surfaces 64a. This can provide another specific configuration in which the sound in the high-pitched sound range emitted from the right loudspeaker 50R and reflected by the two reflection surfaces 64a is emitted from the upper side of the keyboard 20 towards the player, thereby making it possible to further enhance the uniformity of the sound reaching the player.

Further, the electronic keyboard instrument 1 according to the present embodiment has in the main body case 30 the fourth communication path P4 which extends from the two loudspeakers 50R, 50L to reach above or the upper side of the main body case 30 by way of the upper sides of the two reflection surfaces 64a. This can provide still another specific configuration in which the sound in the high-pitched sound range emitted from the right loudspeaker 50R and reflected by the two reflection surfaces 64a is emitted from the upper side of the main body case 30 towards the player, thereby making it possible to further enhance the uniformity of the sound reaching the player.

Additionally, the electronic keyboard instrument 1 according to the present embodiment has in the main body case 30 the saran net 66 which covers over or the upper sides of the two loudspeakers 50R, 50L. According to this configuration, among the sounds emitted from the two loudspeakers 50R, 50L to reach the upper portion of the back space BS after passing through the saran net 66, the part of the sound in the high-pitched sound range is absorbed by the saran net 66 as a result of passing through the saran net 66. This restrains the sound in the high-pitched sound range reflected by the reflection surfaces 64a of the two reflection units 60 from excessively reaching above or the upper side of the main body case 30, thereby making it possible to further enhance the uniformity of the sound reaching the player.

In the electronic keyboard instrument 1 according to the present embodiment, the left loudspeaker 50L is provided on the left side in the left-right direction in the main body case 30, while the right loudspeaker 50R is provided on the right side in the left-right direction in the main body case 30. Specifically speaking, the left loudspeaker 50L and the right loudspeaker 50R are provided individually on both the left and right end sides in the left-right direction in the main body case 30, and the two reflection units 60 are provided together at the central portion in the left-right direction in the main body case 30. Further, the two reflection units 60 are provided in such a manner that the normal direction of the reflection surface 64a forms an angle of 35 degrees with respect to the left-right direction. According to this configuration, the player is normally positioned at the central portion in the left-right direction on the nearer side of the electronic keyboard instrument 1, and hence, the sound emitted from the right loudspeaker 50R and reflected by the reflection units 60 can be transmitted to the player efficiently.

Here, the embodiment of the present disclosure that has been described heretofore is presented as the example, and hence, there is no intention to limit the scope of the present disclosure by the embodiment. The novel embodiment can be carried out in other various forms, and various omissions, replacements, and modifications can be made thereto without departing from the spirit and scope of the present disclosure. Those resulting embodiments and modified examples thereof are included in the scope and gist of the present disclosure and are also included in the scope of disclosures claimed for patent under claims below and their equivalents.

What is claimed is:

1. An electronic instrument comprising:
a casing;
a controller having multiple operation elements provided in connection with the casing and aligned in a left-right direction of the casing;
a sound emitting unit comprising a low-pitched sound emitting unit provided on a first side in the left-right direction in the casing and configured to emit a low-pitched sound, and a high-pitched sound emitting unit provided on a second side in the left-right direction in the casing and configured to emit a high-pitched sound; and
a reflection unit having a reflection surface configured to reflect a sound and provided between the low-pitched sound emitting unit and the high-pitched sound emitting unit in the casing,
wherein the reflection unit is configured such that the reflection surface is inclined towards the high-pitched sound emitting unit with respect to the left-right direction.

2. The electronic instrument according to claim 1,
wherein the sound emitting unit is provided downwards and backwards of the controller.

3. The electronic instrument according to claim 2, comprising:
a first communication path defined in the casing to extend from the sound emitting unit to reach interspaces defined between the multiple operation elements by way of a front side of the reflection unit and lower sides of the controller.

4. The electronic instrument according to claim 3,
wherein the casing comprises a gap configured to communicate with a front side of the reflection unit and the lower sides of the controller,
wherein the first communication path includes a communication path configured to extend by way of the gap, and
wherein the reflection surface has a height dimension which is larger than a height dimension of the gap.

5. The electronic instrument according to claim 2, comprising:
a second communication path defined in the casing to extend from the sound emitting unit to reach upper sides of the controller by way of a front side of the reflection surface.

6. The electronic instrument according to claim 2, comprising:
a third communication path defined in the casing to extend from the sound emitting unit to reach upper sides of the controller by way of an upper side of the reflection unit.

7. The electronic instrument according to claim 2, comprising:
a fourth communication path defined in the casing to extend from the sound emitting unit to reach an upper side of the casing by way of an upper side of the reflection unit.

8. The electronic instrument according to claim 1, comprising:
a saran net provided in the casing and configured to cover upper sides of the sound emitting unit and the reflection unit.

9. The electronic instrument according to claim 1,
wherein the low-pitched sound emitting unit is provided on a left side in the left-right direction in the casing, and
wherein the high-pitched sound emitting unit is provided on a right side in the left-right direction in the casing.

10. The electronic instrument according to claim 9,
wherein the low-pitched sound emitting unit and the high-pitched sound emitting unit are provided individually on both end sides in the left-right direction in the casing, and
wherein the reflection unit is provided at a central portion in the left-right direction in the casing.

11. The electronic instrument according to claim 1,
wherein the reflection unit is configured such that a normal direction of the reflection surface is oriented towards the high-pitched sound emitting unit rather than a front direction of the casing.

12. The electronic instrument according to claim 11,
wherein the reflection unit is configured such that the normal direction of the reflection surface forms an angle ranging from 30 degrees to 40 degrees with respect to the left-right direction.

13. The electronic instrument according to claim 1,
wherein the reflection unit is configured such that the reflection surface is perpendicular to a bottom plate of the casing.

14. An electronic keyboard instrument comprising:
the electronic instrument according to claim 1,
wherein the controller includes a keyboard having multiple keys.
